(19) United States
(12) Patent Application Publication
(10) Pub. No.: US 2004/0143534 A1
(43) Pub. Date: Jul. 22, 2004

(54) Computer aided advisory system and method of using the same

(76) Inventor: Eugene M. Musselwhite III, Charlotte, NC (US)

Correspondence Address: Tony D. Alexander, TECHNOLOGY LEGAL COUNSEL LLC, P.O. Box 1728, Evans, GA, 30809, US

(21) Appl. No.: 10/697,063

(22) Filed: Oct. 30, 2003

Related U.S. Application Data
(60) Provisional application No. 60/422,634, filed on Oct. 30, 2002.

(51) Int. Cl. G06F 17/60

(52) U.S. Cl. 705/36

(57) ABSTRACT

The present invention provides a computer-aided solution that allows investors to anonymously ask questions and receive answers from registered investment advisors. Prescreened advisors are engaged by the system, which employs a method of providing investment advisory assistance to Intranets of corporations that sponsor 401 k or other retirement plans. In particular, the system would allow users of the corporate intranet to submit questions that would be selected and responded to by qualified advisors. After rounds of questions and answers, the investor may initiate contact with one or more advisors to set-up a direct meeting. Absent such investor intervention, the advisors would not know anything about the investor, only the question the investor posed. This insures the investor remains in control of the relationship and also gives the advisors an incentive to not only answer the investor's questions but to answer them accurately and in a manner most likely to engender trust.

### PRIORITY STATEMENT

This patent application claims the benefit of priority under 35 U.S.C. § 119 to co-pending U.S. provisional application serial No. 60/422,634, filed Oct. 30, 2002.

### COPYRIGHT NOTICE

A portion of the disclosure of this patent document contains material that is subject to copyright protection. The copyright owner has no objection to the facsimile reproduction by anyone of the patent disclosures, as it appears in the Patent and Trademark Office patent files or records, but otherwise reserves all copyright rights whatsoever.

### FIELD OF THE INVENTION

This present invention pertains generally to computer aided information exchange, and more particularly, devices and methods for client oriented investment advisory services.

### BACKGROUND OF THE INVENTION

The relationship between the investor advisor and the client is important though often unproductive. The diminished productivity is generally a function of the asymmetry in information exchange between the investor and client. The client is justifiably apprehensive about sharing intimate detail about his or her financial situation and risk tolerances to a person that they have just met. Like any other meeting between strangers, that is supposed to blossom into a relationship, it takes time for a level of comfort and trust to develop. In the traditional advisor/investor engagement, however, the investor is introduced to the advisor via referral or cold telephone call. Immediately, the investor is encouraged to bare their sole with respect to their financial life in a way many are not even comfortable disclosing to loved ones.

Additionally, many individual investors do not have sufficient familiarity with advisor credentialing practices to determine the level of competence of the prospective advisor. These and other concerns have led to the incomplete information, given by investors to advisors. Without comprehensive information about an investor's financial situation, it is difficult for advisors to provide investors with individualized and adequate investment solutions. In order to address these problems, investors and advisors have turned to the Internet as a means of engaging one another without the awkwardness of the initial face-to-face consultation. Unfortunately, quality has suffered precipitously since there still remains the uncertainty of the quality of advisor on the other end of the connection. Moreover, advisors have no real incentive to give individualized and adequate investment advice absent any pecuniary rewards. As a result, the requests for personal and financial information are transferred to the cyber realm where now the investor has less control over where their information may resurface.

Due to the peculiar nature of investment advice and counsel, there remains a need for a system and method of providing access to investment advisory services and assistance to individuals via intranets maintained by employers/organizations. Therefore, there is an existing need for a computer-aided solution that allows investors to anonymously ask questions and receive answers from registered investment advisors. There is also an existing need for a system that prescreens the advisors to assure the investor users a threshold level of advisor competence. Moreover, there remains a need for a system and method of providing investment advisory assistance to Intranets of corporations that sponsor 401 k or other retirement plans. In particular, the system would allow users of the corporate intranet to submit questions that would be selected and responded to by qualified advisors. After rounds of questions and answers, the investor may initiate contact with one or more advisors to set-up a direct meeting. Absent such investor intervention, the advisors would not know anything about the investor, only the question the investor posed. This insures the investor remains in control of the relationship and also gives the advisors an incentive to not only answer the investor's questions but to answer them accurately and in a manner most likely to engender trust.

### SUMMARY OF EXEMPLARY EMBODIMENTS

Solutions to the problems outlined above are proposed using a device, system and method of routing information. In a preferred embodiment, the investment advisory solution is implemented as a component of an investment related website or corporate intranet. In particular, a closed email circuit that is accessible to the user via their employers Intranet allows for limited two-way communication between a visitor and a community of advisors. The system would allow for each participating advisor to receive the visitor's question, and deliver back to the questioner, an appropriate and timely response that only the visitor will see.

A principle objective, in accordance with an exemplary embodiment of the present invention, is to provide a system and method that allows investors to get questions answered by registered investment advisors without having to reveal their personal information. In the furtherance of this and other objectives, investors submit questions, via the system, which are scrubbed and presented to a universe of registered advisors without any investor identification information.

Still another objective of the present invention is to provide a means of allowing investors to assess the competence and compatibility of registered advisors prior to engaging the advisors. In the furtherance of this and other objectives, the investor may ask an indefinite number of questions to advisors to gather the relevant information they would need to determine if a business relationship should be formed. Moreover, the investor would be provided with detailed information about the advisors in addition to the advisor's responses to the posed question(s).

Yet another objective of the present invention is to provide devices, systems and methods that allow corporations to provide a fringe benefit to their employees by giving them access to competent investment advisors through the corporation's intranet. In the furtherance of this and other objectives, the corporation facilitates the acquisition of essential information by employees, without committing significant in-house resources to the project.

A further objective of the present invention is to provide a communication device, system and method that increases the symmetry of information flow between investor and advisor. To this end, the investor is comfortable giving financial data for purposes of gaining advice in light of the fact that their identity remains unknown. Additionally, the advisor is more inclined and better able to advise such investors because of the extent of financial information and the potential of a future engagement.

An additional objective of the present invention is to provide incentives to an investment advisor to give thorough advice to an unknown user. In the furtherance of this and other objectives, the investment advisors, via corporate intranets and websites, are provided with prime opportunities to interact with investors that by their very present indicate their desire to obtain quality investment advice.

Still another objective of the present invention is to provide a means of allowing users to ask questions that they may be embarrassed to ask an investment advisor in person.

The number and variability of applications, devices, systems and methods, in accordance with the present invention, are limited only by the imagination of the user.

Further objectives, features and advantages of the invention will be apparent from the following detailed description taken in conjunction with the accompanying drawings.

### BRIEF DESCRIPTION OF THE DRAWINGS OF PREFFERED EMBODIMENTS

FIG. 1 is a flow diagram showing the steps of submitting questions in accordance with one aspect of the present invention;

FIG. 2 is a flow diagram showing the steps of answering questions in accordance with one aspect of the present invention;

FIG. 3 is a flow diagram showing the steps of routing questions in accordance with one aspect of the present invention;

FIG. 4 is a schematic diagram showing the question and answer flow of the system and method in accordance with an exemplary embodiment of the invention;

FIG. 5 is a schematic of a screen shot of the user interface in accordance with one aspect of the present invention; and

FIG. 6 is a schematic depictions a response screen of the system and method in accordance with an exemplary embodiment of the invention;

### DETAILED DESCRIPTION OF THE PREFERRED EMBODIMENTS

The email question and answer (Q&A) system is a substantially closed circuit system designed to allow the visitor to navigate to an appropriate web page on a target Website. Once there, the visitor could ask any question relating to financial matters, but would be encouraged to focus on investment related issues. In a preferred embodiment, the visitor would follow these steps. First, the user would be asked to type in their e-mail address*. Second, from a drop down menu, they would be asked to select their state of residence. Third, the investor would choose from a super category that helps to identify the overall nature and focus of the question. In the fourth step, the visitor will also have the option to select (by check box) to identify the company that he/she works for. Finally, the visitor has a dialogue box that would allow for a question of any length. Once the question has been keyed in, the visitor would simply hit the “go” button.

Once the “go” button is pressed, a dialogue box appears that asks, “did you mention your name or any identifying information about you or your family?” If yes, the visitor is encouraged to change it. If they desire to make a change they press the change box (the visitor will be returned to the text of his/her question). If no changes are necessary, the go button is pressed and a thank you screen appears for the visitor that indicates that this question has been delivered to all participating advisors. It will also mention that the advisors are working professionals, so please allow a minimum of five (5) working days for a response. We do not guarantee more than one response. Once the question is sent our database captures the visitors' e-mail, and associated information for returning the advisors response(s).

Once the question has been sent out, all of the participating advisors would receive in their email an html formatted message that says “you have received a question from a visitor to” with a reference to the website or corporate intranet”. The advisor receives that html formatted email and he/she sees a super category, a question, and the originating state. If the visitor has opted for it, the name of the company that employs the visitor may be identified. If an advisor is a state regulated advisor, yet not an advisor for that state,* the advisor may simply disregard that question. By way of non-limiting example, the system may have 100 advisors geographically dispersed in the U.S. Of the 100 advisors, 76 may have opted to participate in this system. However, on this particular occasion, when this visitors question was sent out, only 52 opted to respond.

The visitor will be encouraged to offer as much information as is reasonable to answer a question without giving away identifying information such as name or city, etc. The system is designed to allow individuals to communicate their questions from behind a veil, which the system provides. The visitors' information, such as email address is retained in a database, so that the system can facilitate the return of the responses to the person that asked the question, not for any other purpose. However, under no circumstances, is that information made available to the advisors. The only identifying information that is shared is the state that the visitor is in, which is for regulatory requirements. The only information, which can be shared by the visitor is the company they work for, which is optioned by the employee via a check box. It is by the IP address of the intranet link via our database that allows the check box to identify the employer. In a preferred embodiment, this will allow for the employers' 401 k or other plan document to be housed in, for example Portable Delivery Format (PDF) that can be opened up by the advisor for the purpose of helping an employee.

Before the information is sent, a dialogue box will pop up and mention that visitors are actively encouraged not to mention their name, or any other identifying information in the communication. The purpose of which is to keep the identity of the visitor protected.

When the advisor(s) answer the question, the only thing that they will be able to do is type into the available dialogue box, the answer/suggestion. The information the visitor receives back will be in an html formatted page that has the following information:

Advisor Response. Contact data for the responding advisor, including name, address, telephone number, etc. in the form of a banner advertisement that if clicked upon takes the visitor over to that advisors applet page.

Following the banner, would be a repeat of the super category, the actual question and the answer provided by the advisor. This is the limit of that communication. The information that the advisor(s) email back will come back through our system and be logged with an identifier that associates the original question with its answers. For example, the following question is asked: What is the S&P 500? All conditions are fine with the content—no giveaways of information. The question is sent out in html format to the 76 advisors choosing to participate. When the question is sent out, an identifier eg., 06012002-01 (Jun. 1, 2002—question 01) goes along. The first email response, received is tagged 06012002-01 a (meaning that it is the first response to the first question of that day). Each question sent, combined with all answers received will be logged in the database. Also, at the point of origination and with the visitor's approval, the question asked, minus all identifying information may be posted on a website Q&A page along with the first answer. The follow on answers will be accessible via a link, so that if a follow on visitor wants to see if a certain bit of info that might be helpful, but which is not in the first answer, may be in another.

Once the question has been sent and the response received by the visitor's email and logged onto our Q&A database (minus any identifying information, such as one's name) the circuit is complete. If the response that the visitor receives needs more information to be complete, the visitor will not be able to simply hit the email reply button to receive clarification (because this action may leave open the visitors email address). The visitor will have to hit the “additional comments” button that is only visible on the response page, which automatically takes the visitor to the Q&A page again, but with the information already logged in and ready. The remaining steps will be as they were on the initial question. The purpose for not allowing the visitors information to be revealed is simply protection, anonymity and comfort for the visitor. The benefit for the advisor is the ability to showcase their skills to people that have an express need for an advisor.

The system and method of posting questions may be adapted from U.S. Pat. No. 5,948,054, which is incorporated herein by this reference. However, the present invention does not require payment information be provided by the user. Moreover, the system does not have to utilize complicated algorithms to select one advisor over another, since the user should make the choice of advisor. In the furtherance of this and other objectives, the user's question is submitted to a universe of registered investment advisors and the user will have the opportunity to benefit from multiple perspectives.

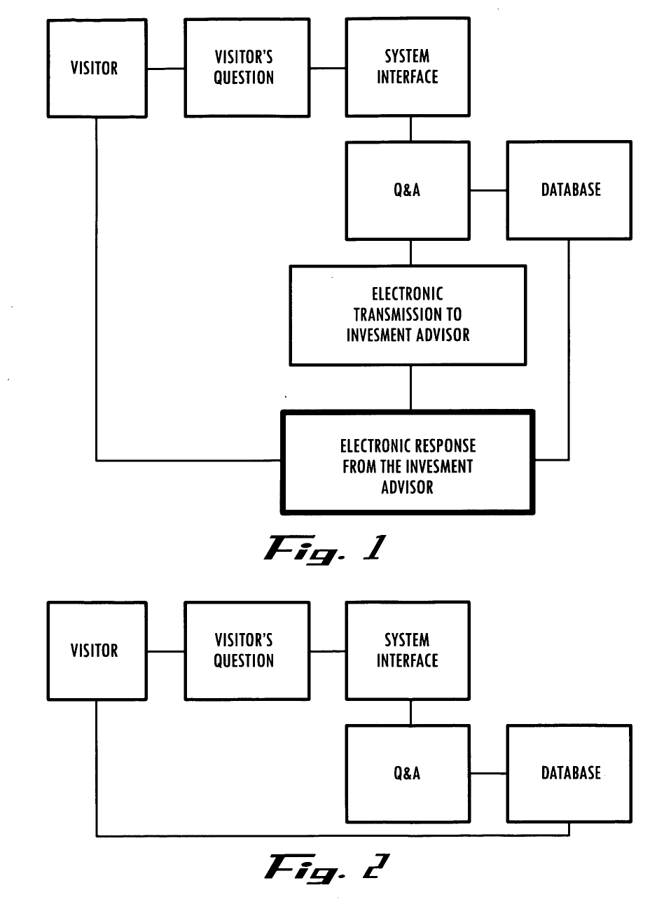

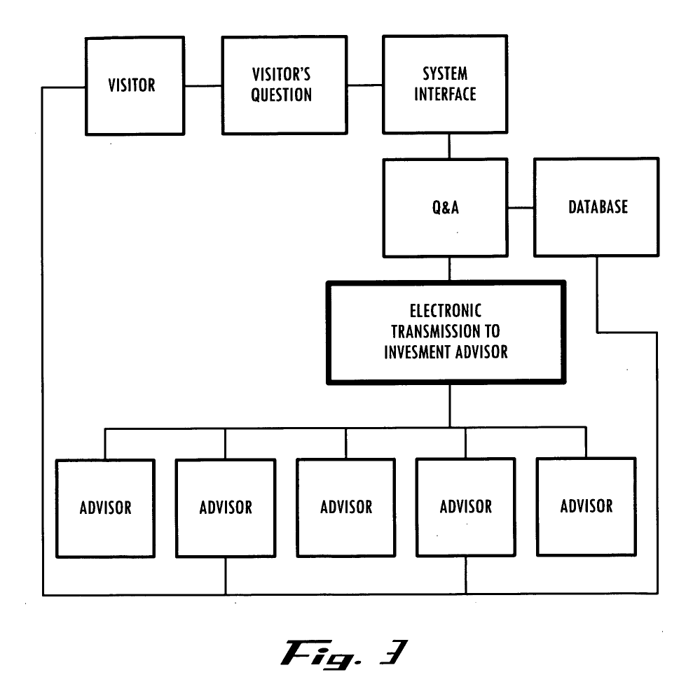

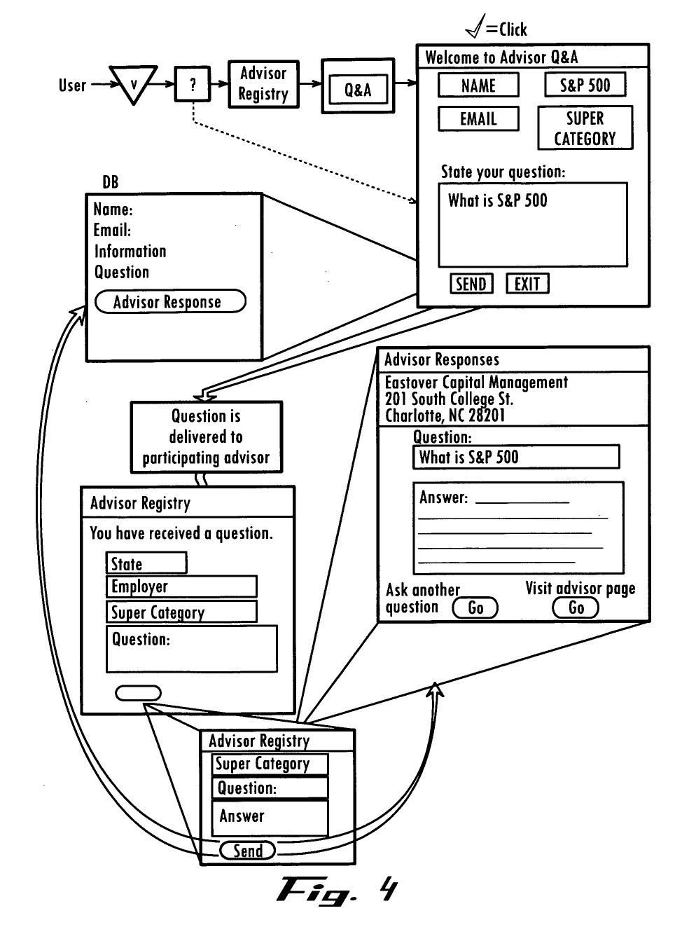

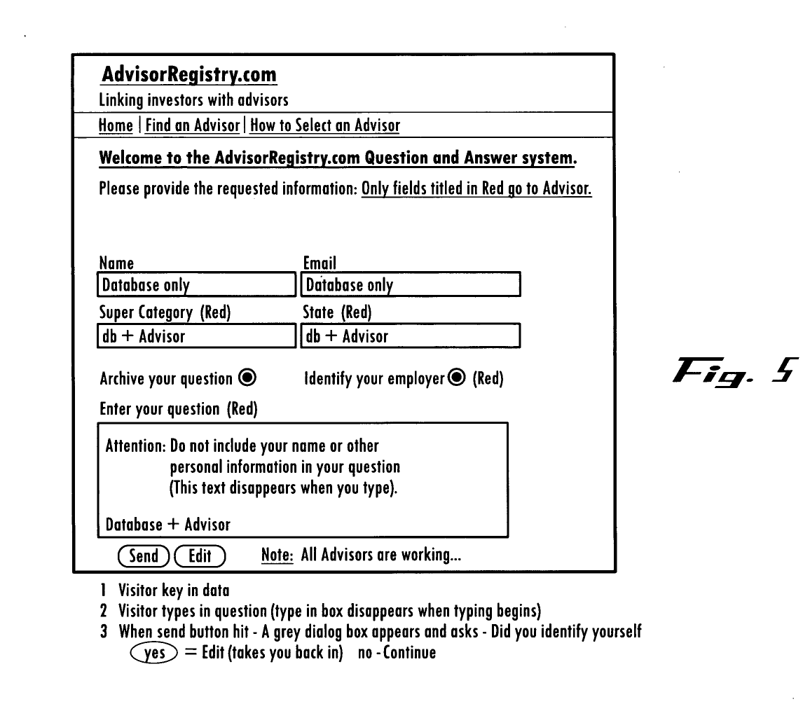

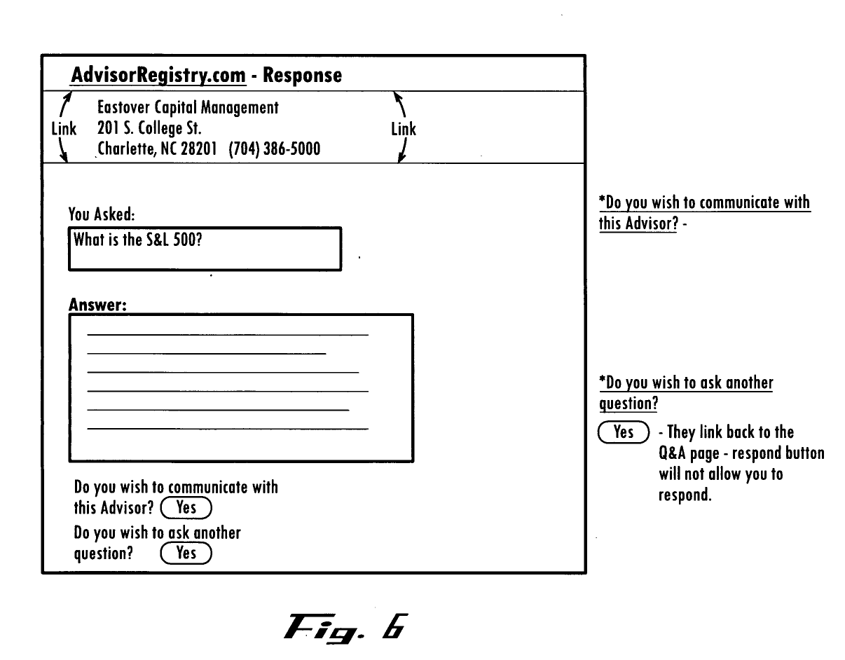

As shown in FIGS. 1-3 the visitor's questions can be routed to an individual advisor, to a universe of advisors or to the system database and/or frequently asked questions database. Moreover, as shown in FIGS. 4-6, the query system can consist of any number of fields that broaden or narrow the universe of advisors, the information to be requested or the database to be accessed. The visitor is given significant control over their search experience.

In alternative embodiments, the system comprises a database driven question and answer interface that allows the user to submit questions, which is routed through the database to qualified investment advisors in the database. Anonymity is marinated as in the above embodiment with the additional advantage of having a low maintenance relational database distribute questions to relevant advisors. The interaction with the advisors is now driven off of the database, with only notification of receipt of a question/comment (for advisors) or answer (for the visitors). The notifications are sent via email with an embedded link to the database with or without ones codes already logged in (to save a step) from which the advisor or visitor which ever was being notified can then log onto the system and retrieve the question or answer(s).

The database is designed to allow the user to ask questions without geographical limitations on who provides the answers. Certain financial questions may warrant that the answer be provided not only by a qualified consultant in the user's country but also preferably in the city of the user. However, in other cases the nature of the information request may require that the information be provided by a qualified consultant in another country. For example, if the question pertains to financial transactions in Greece and the user does not live in Greece, it would be necessary to ensure that the consultant is qualified to opine on Greek law. To facilitate this, a preferred module of the database provides language translation so that the user and the consultant can communicate through the database without knowing the respective language of the other. Exemplary languages in the system includes but is not limited to Afrikaans, Aleut, Aninishinaabe (Chippewa/Ojibwe), Arabic, Armenian, Azerbaijani, Basque, Bengali, Bosnian, Braille, Bulgarian, Chamorro, Cherokee, Cheyenne, Chinese, Chinook, Choctaw, Cornish, Cree, Croatian, Czech, Dakota, Dutch, Esperanto, Estonian, Farsi/Persion, Finnish, French, Georgian, German, Greek, Gujarati, Hawaiian, Hebrew, Hindi, Hmong, Hungarian, Hupa, Icelandic, Indonesian, Inuktitut, Inupiaq, Irish (Gaelic) Italian, Japanese, Kikuyu, Kiribati, Korean, Kurdish, Latin, Latvian, Lithuanian, Luganda, Malaysian, Maltese, Maori, Mayan, Miwok, Mohawk, Mon, Mongolian, Nahuatl (Aztec), Navajo, Ndbele, Norwegian, Paiute, Polish, Portuguese, Potawatomi, Quechua, Romanian Russian, Saami (Lapp), Samoan, Scottish Gaelic, Seneca (Mingo), Serbian, Sesotho, Shona, Sign Language, Sinhalese, Spanish, Swahili, Swedish, Tagalog, Tahitian, Tai, Tamil, Tibetan, Tlingit, Turkish, Urdu, Ukrainian, Vietnamese, Welsh, Xhosa, Yiddish, Yupik and Zulu.

While specific embodiments have been described herein for purposes of illustration, various modifications may be made without departing from the spirit and scope of the invention. It is intended that the spirit and scope of the invention are to be defined by reference to the following claims, along with their full scope of equivalents.

What is claimed is:

1. A computer implemented method for facilitating the exchange of investment information between human users in a networked computer environment, comprising the steps of:
receiving an information request or query from a human user via a user email account, wherein the information request does not specify a source from which the requested information can be obtained;
soliciting the requested information from a database of qualified consultants;
determining whether a qualified consultant user wishes to provide the requested information;
receiving the requested information or answer from the qualified consultant via a computer; and
sending the requested information to the customer user via the customer's email account.

2. A computer implemented method for facilitating the exchange of investment information between human users in a networked computer environment, comprising the steps of:
receiving an information request or query from a human user via a database;
determining whether a qualified consultant user wishes to provide the requested information;
soliciting the requested information from qualified consultants in the database;
receiving the requested information or answer from the qualified consultant via a computer; and
sending to the customer user notification that information is available via the customer's email account.

3. The method of claim 2, the method further comprising the step of screening consultants based on certain criteria.

4. The method of claim 3, wherein the criteria are selected from the group consisting of geographical location, education, licensure, years of experience and combinations thereof.

5. The method of claim 2, further comprising the step of accessing the database to obtain the requested information.

6. The method of claim 5, wherein the database is accessed via a hyperlink to the database user interface.

7. The method of claim 2, further comprising the step of translating the query from an origin language to a target language before being made available to the consultant.

8. The method of claim 7, wherein the query or the answer are in a language other than English.

9. The method of claim 8, wherein the language is selected from the group consisting of Afrikaans, Aleut, Aninishinaabe (Chippewa/Ojibwe), Arabic, Armenian, Azerbaijani, Basque, Bengali, Bosnian, Braille, Bulgarian, Chamorro, Cherokee, Cheyenne, Chinese, Chinook, Choctaw, Cornish, Cree, Croatian, Czech, Dakota, Dutch, Esperanto, Estonian, Farsi/Persion, Finnish, French, Georgian, German, Greek, Gujarati, Hawaiian, Hebrew, Hindi, Hmong, Hungarian, Hupa, Icelandic, Indonesian, Inuktitut, Inupiaq, Irish (Gaelic) Italian, Japanese, Kikuyu, Kiribati, Korean, Kurdish, Latin, Latvian, Lithuanian, Luganda, Malaysian, Maltese, Maori, Mayan, Miwok, Mohawk, Mon, Mongolian, Nahuatl (Aztec), Navajo, Ndbele, Norwegian, Paiute, Polish, Portuguese, Potawatomi, Quechua, Romanian Russian, Saami (Lapp), Samoan, Scottish Gaelic, Seneca (Mingo), Serbian, Sesotho, Shona, Sign Language, Sinhalese, Spanish, Swahili, Swedish, Tagalog, Tahitian, Tai, Tamil, Tibetan, Tlingit, Turkish, Urdu, Ukrainian, Vietnamese, Welsh, Xhosa, Yiddish, Yupik and Zulu.

10. The method of claim 2, wherein the requested information is solicited from qualified consultants via an email information request generated by the database.

11. The method of claim 10, wherein the email information request does not identify the user that initiated the information request.

12. An article of manufacture comprising a computer-readable medium having stored thereon instructions adapted to be executed by a processor, the instructions which, when executed, define a series of steps to facilitate a user's ability to obtain financial information from a consultant, said steps comprising:
receiving an information request from a human user via a database;
determining whether a qualified consultant user wishes to provide the requested information;
soliciting the requested information from qualified consultants in the database;
receiving the requested information from the qualified consultant via a computer; and
sending to the customer user notification that information is available via the customer's email account.

13. The article of manufacture of 12, further comprising the step of screening consultants based on certain criteria.

14. The article of manufacture of claim 13, wherein the criteria are selected from the group consisting of geographical location, education, licensure, years of experience and combinations thereof.

15. The article of manufacture claim 12, further comprising the step of accessing the database to obtain the requested information.

16. The article of manufacture of claim 15, wherein the database is accessed via a hyperlink to the database user interface.

17. The method of claim 12, further comprising the step of translating the query from an origin language to a target language before being made available to the consultant.

18. The method of claim 17, wherein the query or the answer are in a language other than English.

19. The method of claim 18, wherein the language is selected from the group consisting of Afrikaans, Aleut, Aninishinaabe (Chippewa/Ojibwe), Arabic, Armenian, Azerbaijani, Basque, Bengali, Bosnian, Braille, Bulgarian, Chamorro, Cherokee, Cheyenne, Chinese, Chinook, Choctaw, Cornish, Cree, Croatian, Czech, Dakota, Dutch, Esperanto, Estonian, Farsi/Persion, Finnish, French, Georgian, German, Greek, Gujarati, Hawaiian, Hebrew, Hindi, Hmong, Hungarian, Hupa, Icelandic, Indonesian, Inuktitut, Inupiaq, Irish (Gaelic) Italian, Japanese, Kikuyu, Kiribati, Korean, Kurdish, Latin, Latvian, Lithuanian, Luganda, Malaysian, Maltese, Maori, Mayan, Miwok, Mohawk, Mon, Mongolian, Nahuatl (Aztec), Navajo, Ndbele, Norwegian, Paiute, Polish, Portuguese, Potawatomi, Quechua, Romanian Russian, Saami (Lapp), Samoan, Scottish Gaelic, Seneca (Mingo), Serbian, Sesotho, Shona, Sign Language, Sinhalese, Spanish, Swahili, Swedish, Tagalog, Tahitian, Tai, Tamil, Tibetan, Tlingit, Turkish, Urdu, Ukrainian, Vietnamese, Welsh, Xhosa, Yiddish, Yupik and Zulu.

20. The method of claim 12, wherein the requested information is solicited from qualified consultants via an email information request generated by the database.

21. The method of claim 20, wherein the email information request does not identify the user that initiated the information request.
